(19) United States
(12) Patent Application Publication
(10) Pub. No.: US 2017/0028330 A1
(43) Pub. Date: Feb. 2, 2017

(54) Porous Filter Media for Use in Preventing Liquid Carryover

(71) Applicant: Cummins Filtration IP, Inc., Columbus, IN (US)

(72) Inventors: Saru Dawar, McFarland, WI (US); Scott W. Schwartz, Cottage Grove, WI (US); Anna Balazy, Columbus, IN (US); Barry M. Verdegan, Stoughton, WI (US); Brian W. Schwandt, Fort Atkinson, WI (US); Vincil A. Varghese, Stoughton, WI (US); Shiming Feng, Wuhan (CN)

(73) Assignee: Cummins Filtration IP, Inc., Columbus, IN (US)

(21) Appl. No.: 15/218,869

(22) Filed: Jul. 25, 2016

Related U.S. Application Data
(60) Provisional application No. 62/198,903, filed on Jul. 30, 2015.

(51) Int. Cl. B01D 46/00; B01D 46/24

(52) U.S. Cl. CPC B01D 46/003; B01D 46/0056; B01D 46/2403; B01D 2275/30; B01D 2279/35; F01M 13/04

(57) ABSTRACT

A filter assembly for separating liquid from a fluid mixture that includes a filter housing with an inner surface, a filter element configured to separate a liquid from a fluid mixture and defining an outer surface, and a porous filter media. The filter element is positioned within the filter housing such that the outer surface of the filter element faces the inner surface of the filter housing. The porous filter media is attached to the inner surface of the filter housing to facilitate drainage of the liquid through the filter housing and prevent liquid carryover after the fluid mixture flows through the filter element.

### CROSS-REFERENCE TO RELATED APPLICATION

The present application claims priority to U.S. Patent Application No. 62/198,903, filed Jul. 30, 2015, the contents of which are incorporated herein by reference in its entirety.

### FIELD

The present application relates generally to a filter assembly for separating liquid from a fluid mixture.

### BACKGROUND

In certain filter assemblies, such as rotating coalescers and centrifugal systems used for crankcase ventilation, coalesced oil drops released from the moving part may be “flung” off of the coalescer media and deposited on the walls of the filter housing. Due to high g-forces, the coalesced oil drops may also generate smaller satellite drops due to film or drop breakup. The satellite drops typically have a smaller diameter than the coalesced oil drops, and the satellite drops may become re-entrained into the flow of filtered gas toward the gas outlet.

Additionally, on the inside walls of the filter housing, the coalesced oil drops and the satellite drops may coalesce into large drops or pools of oil that are exposed to wall shear stress. The wall shear stress may induce oil carryover, i.e., when the oil flows downstream and contaminates the clean, filtered gas. Contaminated gas can damage the turbocharger in closed crankcase ventilation applications, or can be released into the environment in open crankcase ventilation applications.

Accordingly, it is detrimental for filter assemblies to have oil carryover.

### SUMMARY

Various embodiments provide a filter assembly for separating liquid from a fluid mixture that includes a filter housing with an inner surface, a filter element capable of separating a liquid from a fluid mixture and defining an outer surface, and a porous filter media. The filter element is positioned within the filter housing such that the outer surface of the filter element faces the inner surface of the filter housing. The porous filter media is attached to the inner surface of the filter housing. The porous filter media facilitates drainage of the liquid through the filter housing and prevents or reduces liquid carryover after the fluid mixture flows through the filter element.

Various other embodiments relate to a filter housing assembly. A filter housing includes an inner surface. The filter housing is sized and configured to house a filter element therein in a manner such that and outer surface of the filter element faces the inner surface of the filter housing, the filter element configured to separate a liquid from a fluid mixture. A porous filter media is attached to the inner surface of the filter housing. The porous filter element is configured and positioned so as to retain drops of liquid expelled by the filter element during a filtering operation.

These and other features (including, but not limited to, retaining features and/or viewing features), together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a cross-sectional, top view of a filter assembly according to one embodiment.

FIG. 2 is a cross-sectional, side view of the filter assembly of FIG. 1.

FIG. 3 is a graph showing an improvement in fractional efficiency of a filter assembly including the porous filter media compared to a filter assembly without the porous filter media.

### DETAILED DESCRIPTION

Referring to the figures generally, various embodiments disclosed herein relate to a filter assembly comprising a filter housing, a filter element within the filter housing, and a porous filter media between the filter housing and the filter element. The porous filter media captures and holds liquid droplets expelled by the filter element until the liquid drains from the porous filter media. This aids in preventing or reducing liquid (e.g., oil) carryover within the filter assembly (e.g., oil migration) and allows the filter assembly to behave reliably under engine operating conditions for extended periods of time in a cost effective manner. The filter assembly uses coalescence, centrifugal forces, gravity forces, impaction, and wicking in order to facilitate the drainage of liquid through the filter assembly. The porous filter media does not increase the pressure drop, reduce the filter element life, increase the energy requirements, or reduce liquid droplet removal efficiency. The filter assembly with the porous filter media is reliable, robust, and cost-effective at separating a liquid from a fluid mixture and optionally filtering the fluid mixture.

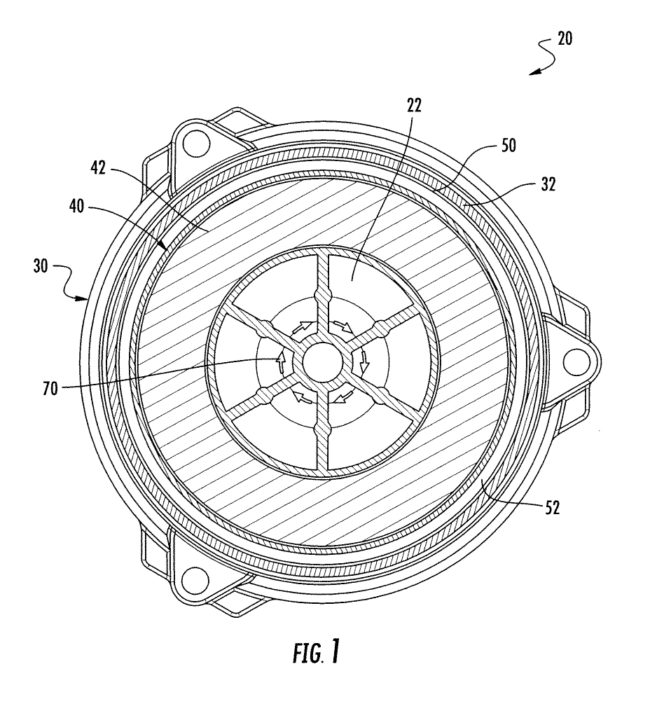

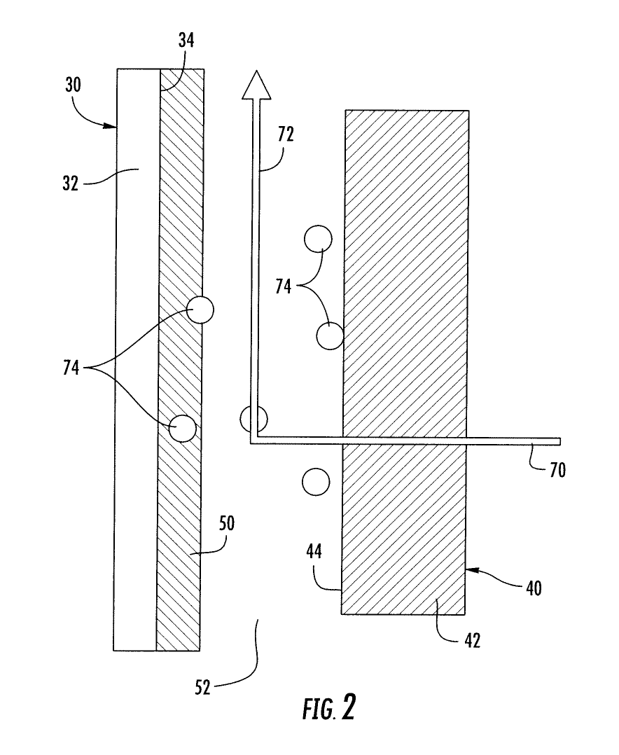

Referring to FIGS. 1-2, there is shown a filter assembly 20 that is configured to filter a fluid mixture 70 by separating the fluid mixture 70 into a liquid 74 (e.g., liquid droplets, such as an oil) and a gas 72, according to one embodiment. The filter assembly 20 may be configured to filter the fluid mixture 70 through a variety of different methods, including coalescence. According to one embodiment, the filter assembly 20 may be a rotating crankcase ventilation separator or system, a rotating system (e.g., a rotating coalescer a rotating stacked disk, or a spiral vane), or a centrifugal system (e.g., a centrifugal separator or a rotating centrifuge).

The filter assembly 20 includes an inlet 22 for the fluid mixture 70 to enter into the filter assembly 20 and a gas outlet downstream of the inlet 22 for the filtered gas 72 to exit the filter assembly 20. The gas outlet may be located on the upper end of the filter housing 30. The liquid 74 may drain to a separate liquid outlet or may be held in a container or certain area of the filter assembly 20, which may be toward the lower end of the filter housing 30 in particular implementations. The filter assembly 20 includes a filter housing 30 and a filter element 40. The filter element 40 may use coalescence and/or centrifugal forces to filter or separate the fluid mixture 70 into the filtered gas 72 and the liquid 74.

### Filter Housing

The filter housing 30 is configured to house or contain the filter element 40. The filter housing 30 may include a nonporous wall 32 to prevent leakage from the filter assembly 20 and to provide an impaction or collection surface for coalesced or centrifuged liquid 74 being flung from the filter element 40. The nonporous wall 32 includes an inside or inner surface 34, which may correspond to the inner diameter of the filter housing 30.

### Filter Element

The filter element 40 (e.g., a coalescer, rotating, or a centrifugal element) is used to filter the fluid mixture 70 by separating the liquid 74 from the gas 72. The filter element 40 may be a filtering or separating device of any kind (e.g., a coalescing filter or a centrifugal separator) and may optionally be a rotating device.

According to one embodiment, the filter element 40 may be a rotating or stationary coalescer. Accordingly, the filter element 40 may include a primary filter media 42 (e.g., coalescer or centrifugal media) to filter the fluid mixture 70.

According to another embodiment, the filter element 40 may be a rotating centrifugal separator, filter, or system, such as a cone-stack or spiral vane centrifuge element that filters or separates the fluid mixture 70. Accordingly, the filter element 40 may include cones, plates or vanes and may optionally not include the primary filter media 42.

The filter element 40 may have an inside-out flow of the fluid mixture 70. The filter element 40 has a downstream side, edge, face, or outer surface 44. The outer surface 44 may be along the outside of the filter element 40 (e.g., along the outside of the primary filter media 42 when the filter element 40 is a coalescer, along the outside of the centrifugal separator rotor when the filter element 40 is a centrifugal separator with cones or spiral vanes, or along the outside of cones or spiral vanes of the centrifugal separator rotor when the filter element 40 is a centrifugal separator with cones or spiral vanes encased in a shell). The filter element 40 is positioned downstream of the inlet 22 and upstream of the gas outlet.

The nonporous wall 32 of the filter housing 30 surrounds the filter element 40 when the filter element 40 is positioned within the filter housing 30 and the outer surface 44 of the filter element 40 faces the inner surface 34 of the filter housing 30. There may be a space, gap, or separation that physically separates the nonporous wall 32 of the filter housing 30 and the filter element 40 in order to allow the gas 72 to flow through toward the gas outlet. For example, there may be a space, gap, or separation between the inner surface 34 of the filter housing 30 and the outer surface 44 of the filter element 40. Accordingly, the filter element 40 may spin or move within the filter housing 30 relative to the inner surface 34 of the filter housing 30 and the porous filter media 50.

### Porous Filter Media

The filter assembly 20 further includes a boundary layer or porous filter media 50, separate and distinct from any filter media of the filter element 40, attached to the inner surface 34 of the filter housing 30. The porous filter media 50 is configured to prevent, reduce, eliminate, or protect against liquid carryover (e.g., oil carryover) in both normal conditions and angularity conditions (e.g., when the entire filter assembly 20 is tilted or angled) by improving the impaction or collection of the coalesced drops of liquid 74 flung or expelled from the filter element 40. Alternatively or additionally, uncoalesced droplets of liquid 74 may be flung or expelled from the filter element 40 and collected on the porous filter media 50. The porous filter media 50 also facilitates drainage of the liquid 74 from the inner surface 34 of the nonporous wall 32 of the filter housing 30 after the liquid 74 flows through the filter element 40. The porous filter media 50 may optionally act as a secondary filter media after the primary filter media 42 or after the centrifugal separator.

After droplets from the fluid mixture 70 are initially coalesced or centrifuged by the filter element 40, the fluid mixture 70 is separated into filtered gas 72 and liquid 74. As shown in FIG. 2, the filtered gas 72 flows through the filter element 40 and upward toward a gas outlet. The coalesced or centrifuged drops of liquid 74 travel through the primary filter media 42 of the filter element 40 and flow radially out or spin off from the outer surface 44 of the filter element 40 toward the porous filter media 50 located on the inner surface 34 of the nonporous wall 32 of the filter housing 30. Drops or droplets from the separated liquid 74 impact or otherwise collect on the porous filter media 50. The porous filter media 50 draws, wicks, captures, absorbs, or traps the drops of deposited liquid 74 into its structure (e.g., toward the inner surface 34 of the filter housing 30) and retain or hold the liquid droplets until the liquid drains from the porous filter media 50. The porous filter media 50 may also facilitate capturing and retaining any smaller droplets or drops, such as satellite drops that may be generated by the high g-forces from the centrifugal action. The liquid drops (including any satellite drops) may form larger drops or pool on or in the porous filter media 50 and flow or drain downwards (with respect to gravity) toward the bottom of the filter housing 30 within the porous filter media 50 and along the inner surface 34 for liquid drainage or collection. Thus, the porous filter media 50 protects the liquid 74 from shear stresses in the gap 52 and any shear stresses that may be at or near the inner surface 34 of the nonporous wall 32 of the filter housing 30. The shear stress may otherwise cause liquid carryover (e.g., for the liquid 74 to be carried downstream with the filtered gas 72 toward the gas outlet).

As shown in FIGS. 1-2, the porous filter media 50 lines the inner surface 34 of the nonporous wall 32 of the filter housing 30 and may be positioned within the flow path of fluid from the filter element 40 toward the gas outlet. The porous filter media 50 may line the areas of the inner surface 34 that the coalesced or centrifuged drops of liquid 74 from the filter element 40 may deposit or accumulate. According to one embodiment, the porous filter media 50 may line the entire inner surface 34 of the nonporous wall 32 of the filter housing 30. Since the porous filter media 50 is positioned in the space between the filter housing 30 and the filter element 40, the porous filter media 50 does not increase the packaging space of the filter assembly 20. It should be noted, however, that the porous filter media 50 may only line a portion of the inner surface 34 of the nonporous wall, and in such implementations, the particular portions of the inner surface 34 of the nonporous wall which are lined with the porous filter media 50 may vary depending upon, for example, system requirements and expected use case situations for an associated engine system.

The porous filter media 50 may be temporarily (i.e., removably) or permanently attached to the inner surface 34. According to one embodiment, the porous filter media 50 may be integrated into the inner surface 34. According to another embodiment, the porous filter media 50 may be attached to the inner surface 34 with an adhesive, thermal or ultrasonic bonding, or other chemical or mechanical mechanisms or methods. In some implementations where the connection of the porous filter media 50 to the inner surface 34 is not permanent, the porous filter media 50 can be removed and replaced at regular services intervals, for example, in order to ensure a continued high level of performance.

The porous filter media 50 may be constructed out of a porous material in order to allow the liquid 74 to flow through the porous filter media 50. A porous material is defined as a material that is permeable to fluids and has small pores (e.g., holes) that allow air or liquid to pass through. A pore is defined as a minute opening, especially one by which matter passes through a media, such as a membrane or nonwoven material. Other porous media, such as open cell foams or granular media may also be used. The porous filter media 50 may further comprise a wire mesh (e.g., a wire mesh liner), a woven material (e.g., woven filter media), a nonwoven material (e.g., meltblown or spunbond filter media), or a screen (e.g., a woven screen). The porous filter media 50 may also comprise fibrous materials. For example, the porous filter media 50 may be polymeric (e.g., including polyester, nylon, or polyamide fibers), or the fibers may be meltblown or spunbond. The porous filter media 50 may have an irregular or rough surface in order to create a thicker boundary layer, which further reduces the shear stress on the deposited liquid 74 and allows drops of liquid to coalesce into larger drops or pools to facilitate drainage. In particular embodiments, the porous filter media 50 comprises a high loft filter media, i.e., a filter media that comprises carded, melt spun or melt blown webs, with the solidity of the filter media (the volume of the fibers divided by the total volume of the filter media) being relatively low as would be understood by one of ordinary skill in the art.

### Performance Optimization of the Filter Assembly

The porous filter media 50 may have particular media properties, such as a certain pore size and wettability, and a particular thickness in order to optimize the performance of the filter assembly 20 (e.g., to minimize liquid carryover within the filter assembly 20). For example, in one implementation, the pore size is greater than or equal to the diameter of the coalesced drops of liquid 74 to facilitate penetration of the liquid 74 into the porous filter media 50. In another implementation, the pore size does not exceed twice the dimensions of the coalesced drop of liquid 74 as the drop of liquid 74 leaves the filter element 40 in order to minimize shear stresses on the retained liquid. In certain implementations, the pore size exceeds 15 μm and, in more specific implementations, exceeds 30 μm. However, it is understood that in other embodiments, the pore size may be less than or equal to 30 μm, or more specifically less than or equal to 15 μm in some embodiments. In other embodiments, the pore size may be greater than or equal to 1.5 μm. In certain other implementations, the pore size may be less than or equal to 100 μm and more specifically may be less than or equal to 50 μm.

The porous filter media 50 occupies a portion of the space between the inner surface 34 of the nonporous wall 32 of the filter housing 30 and the outer surface 44 of the filter element 40. As shown in FIGS. 1-2, a separation gap 52 physically separates the outer surface 44 of the filter element 40 from the porous filter media 50. The thickness of the porous filter media 50 may affect the size of the separation gap 52, which affects the performance of the filter assembly 20. Accordingly, the thickness of the porous filter media 50 must be within a certain range in order to optimize the performance (e.g., the pressure drop and liquid removal efficiency) of the filter assembly 20. Particularly beneficial ranges of thickness of the porous filter media 50 (and, therefore, size of the separation gap 52) depend on the outermost diameter of the filter element 40 and the inner diameter of the filter housing 30. Specifically, a porous filter media that is too thick may reduce the thickness of the separation gap 52, which increases the drag on the filter element 40, thus increasing the energy costs and requiring a stronger drive mechanism. In order to achieve the desired filter performance (e.g., the same drag and rotational speed as a thinner porous filter media), a thicker porous filter media would require the inner diameter of the filter housing 30 to be increased and/or the outermost diameter of the filter element 40 to be decreased, both of which are undesirable design tradeoffs. Conversely, a porous filter media that is too thin may not be sufficiently thick to prevent liquid carryover.

In particular embodiments, the minimum thickness of the porous filter media 50 is at least the thickness of the expected size of a coalesced drop of liquid 74. According to one embodiment, the thickness of the porous filter media 50 is between approximately 0.015 mm (i.e., 15 μm) and 3 mm. According to one embodiment, the thickness of the porous filter media 50 is greater than or equal to 0.05 millimeters. According to another embodiment, the thickness of the porous filter media 50 is less than or equal to 1 millimeter. According to yet another embodiment, the thickness of the porous filter media 50 is between approximately 0.05 mm and 1 mm inclusive.

The capillary pressure of the liquid within the porous filter media 50 also should be within a certain range in order to optimize the performance of the filter assembly 20. The capillary pressure is approximately determined by the following equation:

$$\frac{h ρ g π {d}^{2}}{4} = π d γ cos θ \qquad ( 1 )$$

where ρ is the density of the liquid 74 (e.g., oil), h is the vertical height of the liquid column supported by the porous filter media 50, γ is the surface tension of the liquid 74, θ is the contact angle (e.g., the quantitative measure of wettability) of the liquid 74 on the porous filter media 50, g is the acceleration due to gravity, and d is the diameter of the pores within the porous filter media 50. The measurements of all of the parameters may be expressed in the centimeter-gram-second (cgs) system of units. The contact angle θ may be the term θ (see, e.g., FIG. 4) disclosed in U.S. Patent Application Publication No. 2010/0050871, the entire disclosure of which is incorporated herein by reference. It should be noted that, while base materials, such as polyamides, polyesters, or other polymeric materials, have an inherent contact angle θ under a given set of measurement conditions, the magnitude of the contact angle θ for the material can be controlled through the use of coatings, surface treatments, or other mechanisms or methods to achieve the desired contact angle θ, such as those described in U.S. Patent Application Publication No. 2010/0050871.

The porous filter media 50 may be selected that have particular wetting properties in order to obtain the desired performance. Porous filter media 50 with intermediate wetting properties (for example, a porous filter media 50 with pores that are 15 microns or larger) may be preferable, though it is understood that a wider range may be used. For example, the porous filter media 50 may be at least partially wetting and/or not highly oleophobic in order to allow the liquid 74 (e.g., oil) to penetrate and be absorbed or wicked into the porous filter media 50. Accordingly, the contact angle θ may be less than approximately 145° and, more preferably, less than approximately 120°.

Additionally, the porous filter media 50 may be at least partially non-wetting and/or not highly oleophilic in order to allow the liquid 74 (e.g., the oil) to drain from the porous filter media 50. Accordingly, the contact angle θ may be greater than approximately 35° and, more preferably, greater than approximately 60°.

The capillary pressure should also be sufficient to prevent liquid 74 from pooling on the outer surface of the porous filter media 50 where the liquid 74 may be exposed to shear stress and liquid carryover may occur. According to one embodiment and based on equation (1), the porous filter media 50 may have a contact angle θ less than or equal to approximately 90° in order to wick liquid 74 into the porous filter media 50, rather than repel the liquid 74 (e.g., to avoid being oleophobic, in embodiments where the liquid 74 is oil). According to another embodiment, in particular with drops of liquid 74 that are 50 microns or larger, it has also been found that contact angles θ between approximately 90° and 120° may weakly repel liquid 74 such that the distance that the liquid extends away from or beyond the surface of the porous filter media 50 into the separation gap 52 is small enough to reduce liquid carryover.

Although not required, the capillary pressure may also be sufficiently low such that deposited liquid 74 can readily drain from the porous filter media 50. Equation (1) may define the range of pore sizes that can be used within the porous filter media 50. For a given contact angle greater than 90°, when the liquid 74 is lube oil, the liquid height h required to initiate drainage increases rapidly with a decreasing pore size. Therefore, according to one embodiment, the size of the pores (i.e., all of the pores) within the porous filter media 50 may be greater than approximately 15 microns. According to another embodiment, the size of the pores (i.e., all of the pores) within the porous filter media 50 may be greater than approximately 30 microns.

Efficiency Comparison in Filter Assemblies with and without the Porous Filter Media

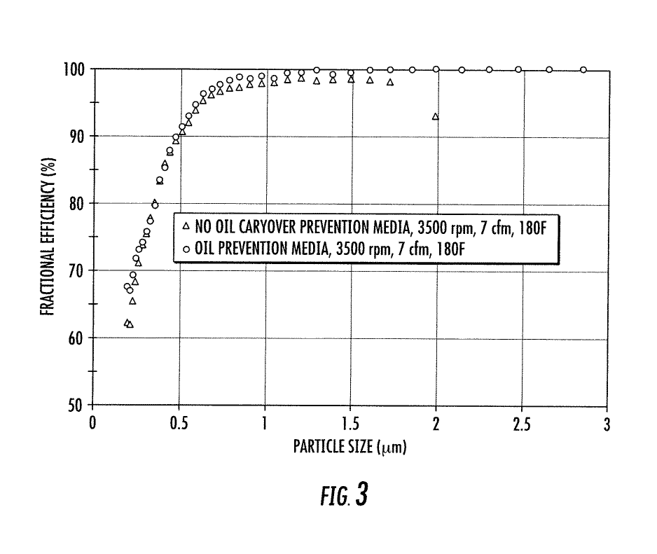

The filter assembly 20 with the porous filter media 50 may reduce the liquid carryover and have an improved efficiency in all angular directions compared to a filter assembly without a porous filter media, as shown, for example, in FIG. 3. To quantify the improvement in efficiency due to the porous filter media, an oil mist was filtered by rotating coalescers with and without a porous filter media. The coalescers were identical, except for the presence or absence of the porous filter media and were tested using the same oil concentration, rotational speed (3500 rpm), flow rate (7 cfm), and temperature (180° F.). The porous filter media was a polyamide filter media with contact angle θ of 0°. An aerosol optical particle counter was used to measure the particle size and concentration of oil droplets upstream and downstream of the rotating coalescers.

As shown in FIG. 3, the fractional efficiency of oil droplet removal was greater for the rotating coalescer with the porous filter media than the identical rotating coalescer without the porous filter media. The increase in fractional efficiency is particularly notable at oil particle (droplet) sizes greater than approximately 1.5 μm, which is due to a reduced oil carryover by using the porous filter media.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

The terms “coupled,” “connected,” “attached,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. Additionally, it should also be understood that features disclosed in different embodiments may be combined into yet further embodiments not necessarily depicted or described herein. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A filter assembly, comprising:
a filter housing including an inner surface;
a filter element configured to separate a liquid from a fluid mixture and defining an outer surface, the filter element positioned within the filter housing such that the outer surface of the filter element faces the inner surface of the filter housing; and
a porous filter media attached to the inner surface of the filter housing.

2. The filter assembly of claim 1, wherein during operation of the filter assembly, coalesced drops of liquid expelled from the filter element are retained by the porous filter media.

3. The filter assembly of claim 2, wherein a size of each of a plurality of pores within the porous filter media is greater than or equal to the diameter of the coalesced drops of the liquid.

4. The filter assembly of claim 1, wherein a size of each of a plurality of pores within the porous filter media is less than or equal to 100 microns.

5. The filter assembly of claim 1, wherein a size of each of a plurality of pores within the porous filter media is less than 50 microns.

6. The filter assembly of claim 1, wherein a thickness of the porous filter media is at least equal to a thickness of the coalesced drops of the liquid.

7. The filter assembly of claim 1, wherein a thickness of the porous filter media is between 0.05 millimeters and 1 millimeter inclusive.

8. The filter assembly of claim 1, wherein the porous filter media defines a plurality of pores therein.

9. The filter assembly of claim 1, wherein the porous filter media is not highly oleophobic and not highly oleophilic.

10. The filter assembly of claim 9, wherein liquid expelled from the filter element contacts the porous filter media at a contact angle between approximately 35° and 145°.

11. The filter assembly of claim 10, wherein the contact angle is between approximately 60° and 120°.

12. The filter assembly of claim 11, wherein the contact angle is approximately 90°.

13. The filter assembly of claim 1, wherein the porous filter media is a nonwoven filter media.

14. The filter assembly of claim 1, wherein the filter assembly is a rotating centrifuge.

15. The filter assembly of claim 1, wherein the filter assembly is a rotating coalescer.

16. The filter assembly of claim 1, wherein a thickness of the porous filter media is greater than or equal to 0.05 millimeters.

17. The filter assembly of claim 1, wherein a thickness of the porous filter media is less than or equal to 1 millimeter.

18. A filter housing assembly, comprising:
a filter housing including an inner surface, the filter housing sized and configured to house a filter element therein in a manner such that and outer surface of the filter element faces the inner surface of the filter housing, the filter element configured to separate a liquid from a fluid mixture; and
a porous filter media attached to the inner surface of the filter housing, the porous filter element configured and positioned so as to retain drops of liquid expelled by the filter element during a filtering operation.

19. The filter housing assembly of claim 18, wherein the porous filter media is permanently attached to the inner surface of the filter housing.

20. The filter housing assembly of claim 18, wherein the porous filter media is temporarily attached to the inner surface of the filter housing.

21. The filter housing assembly of claim 18, wherein the porous filter media defines a plurality of pores therein, each of the plurality of pores each having a size less than or equal to 100 microns.

22. The filter housing assembly of claim 18, wherein the porous filter media defines a plurality of pores therein, each of the plurality of pores each having a size less than or equal to 50 microns.

23. The filter housing assembly of claim 18, wherein a thickness of the porous filter media is between 0.05 millimeters and 1 millimeter inclusive.
